(19) United States
(12) Patent Application Publication
(10) Pub. No.: US 2024/0008693 A1
(43) Pub. Date: Jan. 11, 2024

(54) System for Monitoring Usage of Sanitary Product

(71) Applicant: Tekt Industries Pty Ltd, Abbotsford (AU)

(72) Inventor: Matthew Adams, Collingwood (AU)

(21) Appl. No.: 18/023,499

(22) PCT Filed: Aug. 30, 2021
(86) PCT No.: PCT/AU2021/051004

§ 371 Date: Feb. 27, 2023

(30) Foreign Application Priority Data
Aug. 28, 2020 (AU) 2020903084

(51) Int. Cl. A47K 10/32; G08B 21/24

(52) U.S. Cl. CPC A47K 10/32; G08B 21/24; A47K 2010/3226; A47K 2010/3668

(57) ABSTRACT

A system for monitoring a usage of rolled or stacked disposable sanitary product in a predetermined location or facility and providing information associated with said usage to one or more users, comprising: (a) one or more optical sensors mounted at respective locations associated with where the product is dispensed and configured to monitor a diameter of the roll or height of the stack and transmit data associated therewith; and (b) one or more receivers configured to receive and transmit said data to one or more databases for storage, processing, analysis and/or user notification regarding product usage.

### FIELD OF THE INVENTION

The present invention relates to a system for monitoring the usage of disposable sanitary products, such as rolls or stacks of toilet paper and paper towels.

### BACKGROUND

Disposable sanitary product, such as rolls of toilet paper and rolls or stacks of paper towels are used in virtually every household and place of business, and constantly need stocking up based on the rate at which they are used up.

However, existing systems and methods for monitoring the usage levels of these disposable sanitary products are quite manual and/or labour-intensive and prone to human error. Often, the importance of ensuring a ready supply of sanitary product relies primarily upon one or more people visually inspecting the amount of product remaining and making a judgment about when and how much of the product should be purchased next.

Larger establishments, such as hotels and stadiums may have a more rigorous system in place, but such systems are still relatively dependent on humans performing their product checks and estimations reliably, consistently, and efficiently. Such systems are also prone to human error and inefficiency.

There is a need to address the above, and/or at least provide a useful alternative.

### SUMMARY

According to a first aspect of the present invention, there is provided a system for monitoring a usage of rolled or stacked disposable sanitary product in a predetermined location or facility and providing information associated with said usage to one or more users, comprising:
(a) one or more optical sensors mounted at respective locations associated with where the product is dispensed and configured to monitor a diameter of the roll or height of the stack and transmit data associated therewith; and
(b) one or more receivers configured to receive and transmit said data to one or more databases for storage, processing, analysis and/or user notification regarding product usage.

According to embodiments of the invention, the or each optical sensor periodically monitors product usage and transmits data associated therewith.

According to embodiments of the invention, the or each sensor comprises time-of-flight (ToF) sensor.

According to embodiments of the invention, the or each sensor further comprises an accelerometer for determining a position of the sensor relative to the stack or roll being monitored.

According to embodiments of the invention, the or each sensor and/or the or each receiver comprises means for detecting the presence of a user proximate thereto.

According to embodiments of the invention, the or each sensor and/or the or each receiver comprises means via which a user can alert other users connected to the one or more databases and/or associated networks.

According to embodiments of the invention, the or each sensor is releasably wall mountable.

According to embodiments of the invention, a detection angle of the sensor relative to a surface to which it is mounted is between approximately 25 and 35 degrees.

According to embodiments of the invention, at least one receiver is in the form of a storage means via which two or more rolls or stacks can be stored in a refillable manner.

According to embodiments of the invention, at least one receiver functions as a network gateway.

According to embodiments of the invention, the storage means comprises one or more sensors for detecting the presence of product stored therein.

According to embodiments of the invention, the one or more storage means sensors comprises a proximity sensor configured to detect the presence of a respective stack or roll.

According to embodiments of the invention, the one or more storage means sensors comprises optical sensors configured to detect the presence of one or more stacks or rolls.

According to embodiments of the invention, the one or more storage means optical sensors comprises time-of-flight sensors.

According to embodiments of the invention, the disposable sanitary product monitored comprises one or more rolls of toilet paper.

According to embodiments of the invention, the or each optical sensor is configured to communicate with the or each receiver via Bluetooth.

According to embodiments of the invention, each receiver is configured to communicate to another receiver via Bluetooth and/or Wi-Fi.

According to embodiments of the invention, each receiver is configured to transmit data to the one or more databases via Wi-Fi.

According to embodiments of the invention, the system comprises:
(a) one or more optical sensors mounted relative to respective wall-mounted rolls of toilet paper and configured to monitor and transmit data associated with usage thereof to one or more receivers;
(b) one or more receivers in the form of a first toilet paper roll holder configured with proximity sensors to detect the presence of rolls stored therein; and
(c) one or more receivers in the form of a second toilet paper roll holder and configured with optical sensors to detect the presence of rolls stored therein,
wherein the or each receiver is configured to receive data from the one or more optical sensors and transmit said data to one or more other said receivers and/or to the one or more databases.

According to embodiments of the invention, the system is configured to take one or more automated actions to facilitate the replenishing of the product based on the monitored usage thereof.

### BRIEF DESCRIPTION OF THE DRAWINGS

In order that the invention may be more easily understood, an embodiment will now be described, by way of example only, with reference to the accompanying drawings in which:

FIG. 1 is a first half of a schematic diagram illustrating a system according to embodiments of the present invention;

FIG. 2 is a second half of the schematic diagram of FIG. 1;

FIG. 3 is a front perspective view of an in-situ optical sensor of a system according to embodiments of the present invention;

FIG. 4 is a side view of an in-situ optical sensor of a system according to embodiments of the present invention;

FIG. 5(a) is a front perspective view of the optical sensor of FIG. 4;

FIG. 5(b) is a rear perspective view of the optical sensor of FIG. 5(a);

FIG. 6 is a rear perspective view of a receiver of a system according to embodiments of the present invention, the receiver being in the form of a product storage means;

FIG. 7 is a front view of the storage means of FIG. 6;

FIG. 8 is a bottom perspective view of the storage means of FIG. 7;

FIG. 9 is a schematic side view of the storage means and two optical sensors of a system according to embodiments of the invention;

FIG. 10 is a bottom perspective view of a receiver of a system according to embodiments of the present invention, the receiver being in the form of another product storage means;

FIG. 11 shows three front perspective views of another receiver of a system according to embodiments of the present invention, the receiver being in the form of another product storage means;

FIG. 12 shows three front perspective views of another embodiment of the product storage means of FIG. 11;

FIG. 13 shows a top perspective view of an in-situ receiver of a system according to embodiments of the present invention;

FIG. 14 shows a cross-sectional side view of the receiver of FIG. 13; and

FIG. 15 shows a schematic diagram of a system according to embodiments of the present invention.

### DETAILED DESCRIPTION

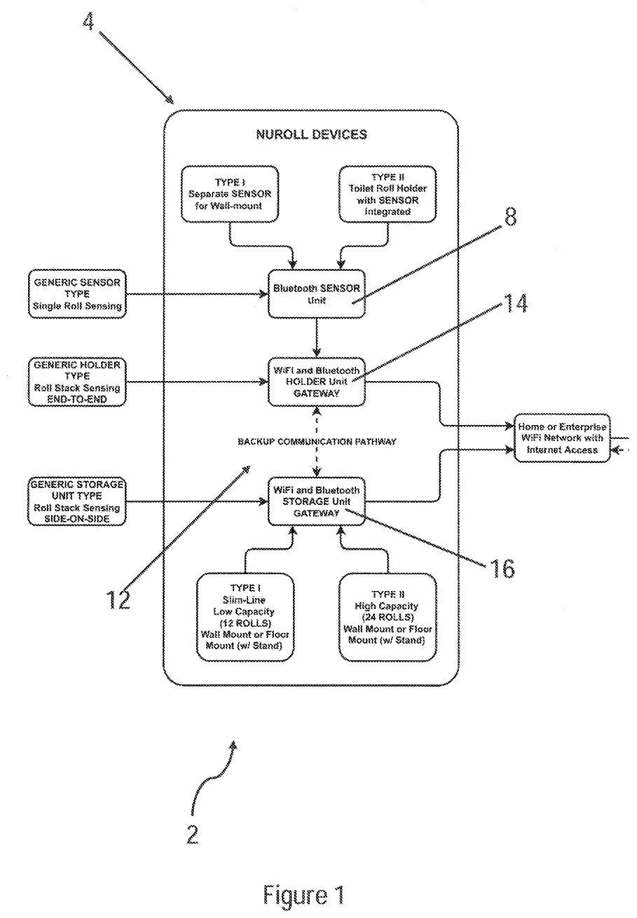

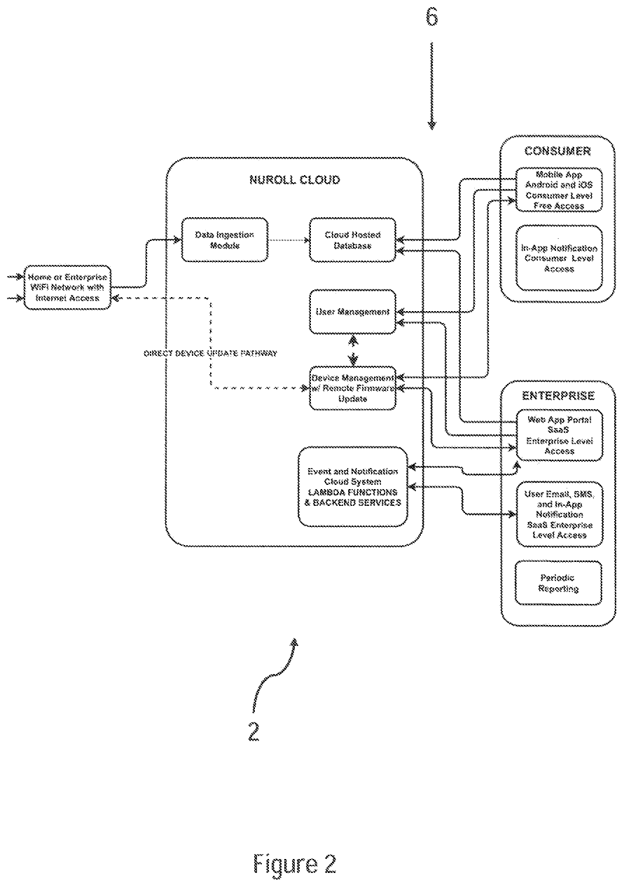

FIGS. 1 and 2, together, show a schematic diagram illustrating an example system 2 according to embodiments of the invention. Effectively, the system 2 comprises smart hardware 4 and software 6 which work together to monitor the usage of disposable sanitary products such as rolls of toilet paper rolls and paper towels, as well as stacked paper towels of a specific and predetermined environment.

For ease of explanation, the present specification will henceforth discuss the system 2 with reference to the monitoring of toilet paper rolls, but it should be appreciated that the system 2 can be configured to similarly monitor other disposable sanitary products, such as stacked paper towels.

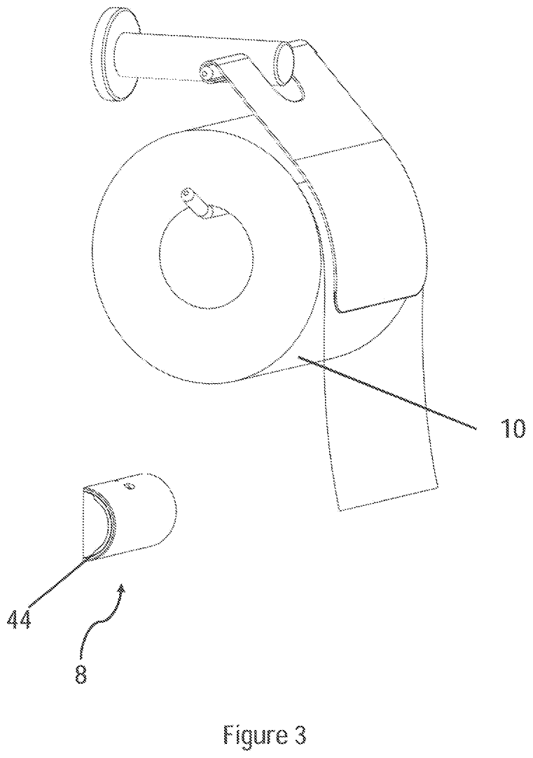

FIG. 1 illustrates a system 2 utilising two types of devices. The first is an optical sensor device 8 (see FIGS. 3 to 5) configured to monitor the usage and depletion levels of respective toilet paper rolls 10, such as a roll 10 that is installed at a bathroom stall ready for use. This usage data is periodically transmitted to a second type of device in the system 2, broadly defined as a receiver 12.

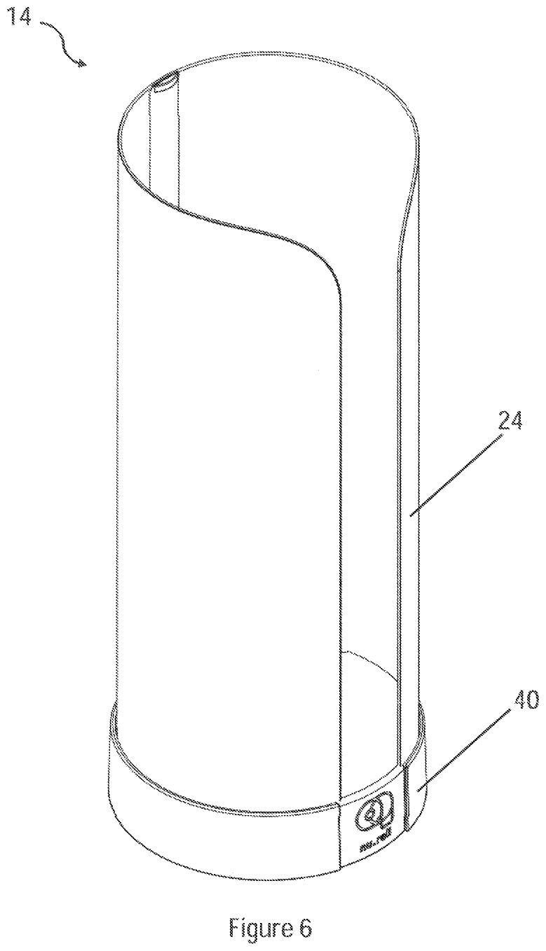

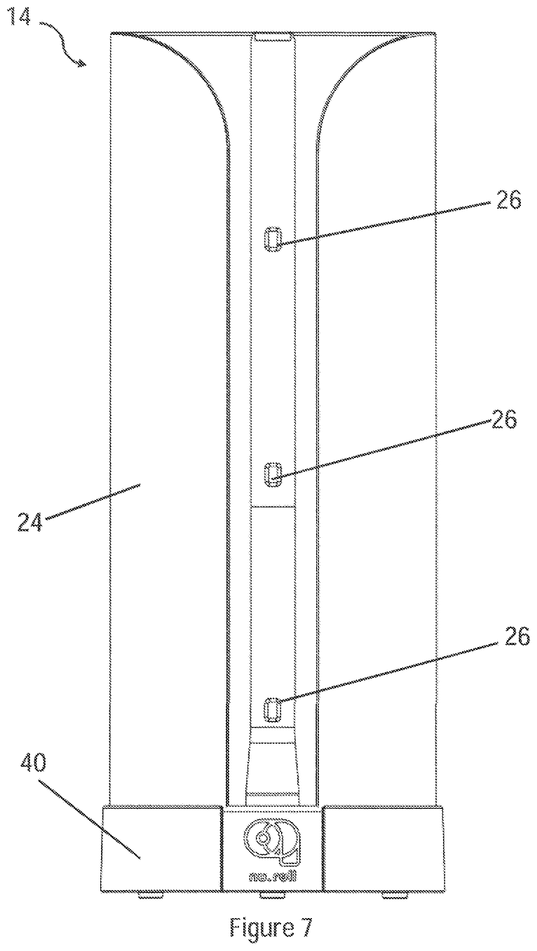

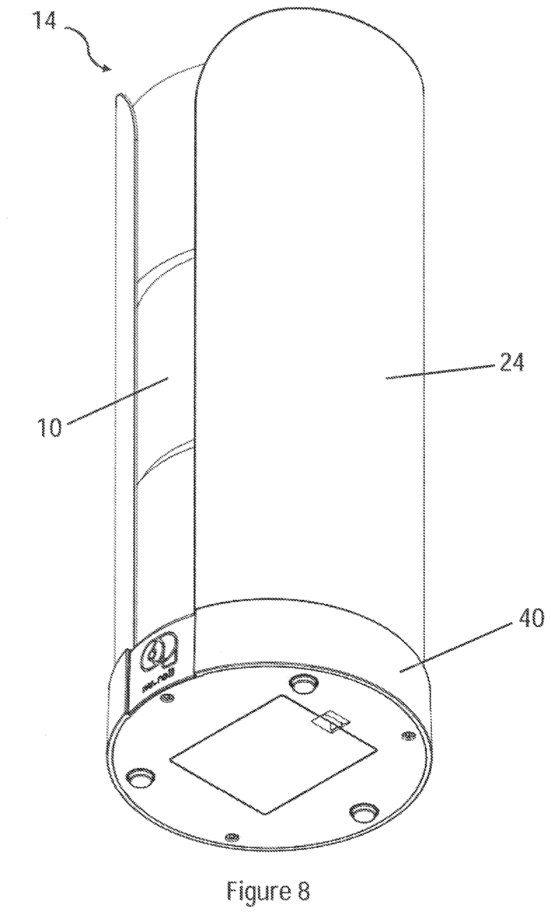

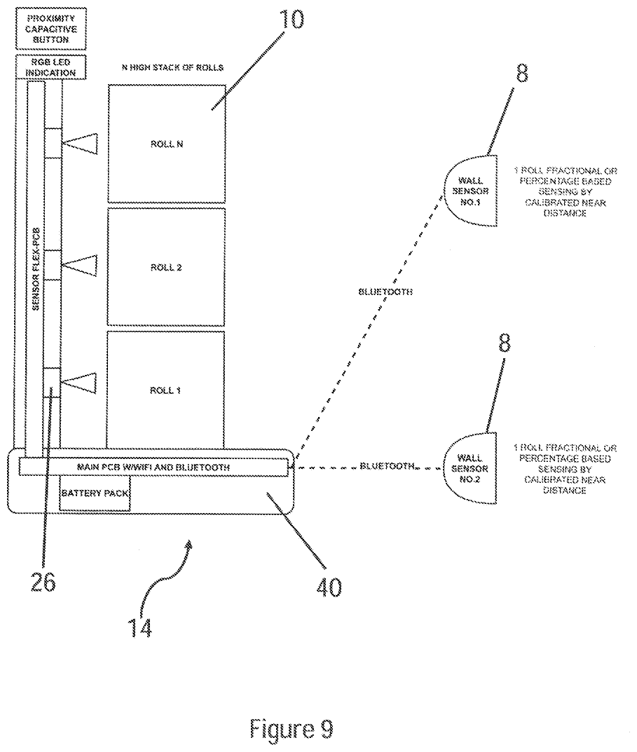

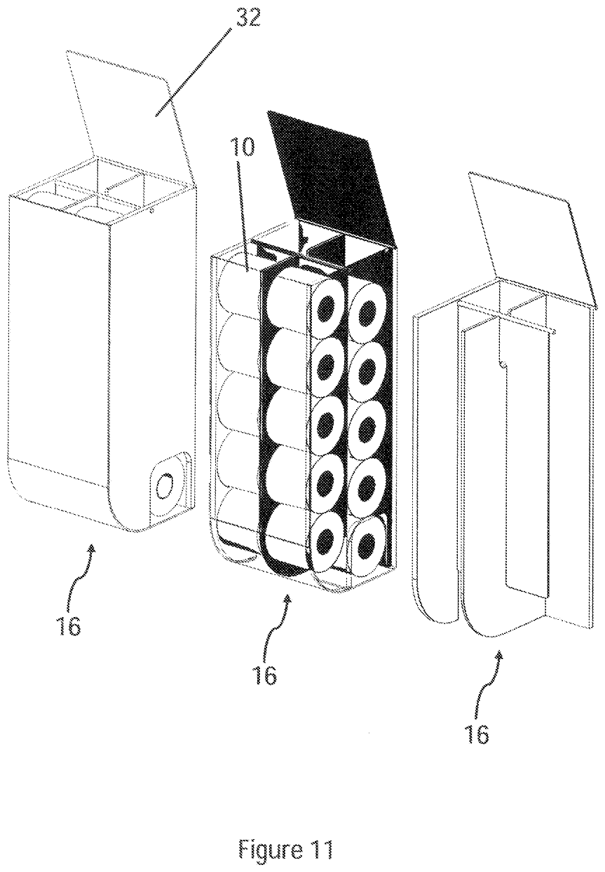

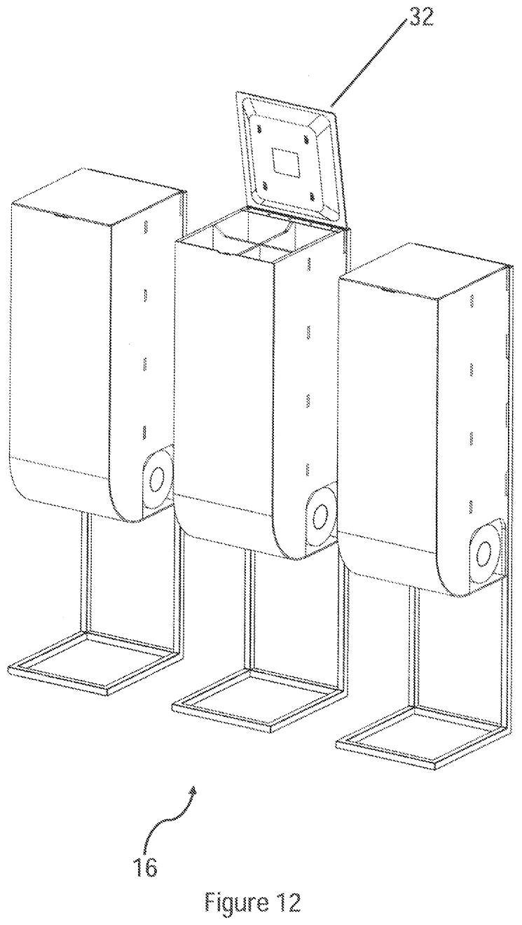

In FIG. 1, there are two such receivers 12, both configured as storage means. The first storage means takes the form of a smart toilet roll holder 14 (see FIGS. 6 to 10) which one might regularly store several rolls of toilet paper in and place next to a toilet. The second storage means takes the form of a larger capacity storage unit 16 (see FIGS. 11 to 14) wherein numerous rolls of toilet paper may be stored 10.

Both types of storage means 14, 16 are configured with sensors to monitor how many toilet rolls 10 are stored therein. The storage means 14, 16 are also configured to receive data from the optical sensor devices 8 and transmit this data to one or more databases via Wi-Fi for storage, processing, analysis, notifying users etc (FIG. 2).

The devices 4 of the system 2 are preferably battery-powered and the communication pathways thereof are configured to reduce power consumption. In the depicted example, the optical sensor 8 may transmit its collected data directly to a receiver 12 via Bluetooth Low Energy (BLE). Similarly, each receiver 12 of the system 2 may also communicate data to and from one another via BLE. As such, it is possible to achieve a system 2 wherein only one receiver 12 transmits the collected data to one or more databases via Wi-Fi.

To further reduce power consumption and thus increase the longevity of the devices 4 of the system 2, the devices 4 may be configured to monitor usage levels and transmit associated data only periodically. For example, the optical sensor 8 might only collect usage information of an associated toilet roll every two hours, or, for example, each time a user is detected to have flushed a toilet. Similarly, the receiver 12 configured to collect data from every other device 4 and transmit it to one or more databases may be configured to activate Wi-Fi for such purposes only once per day, for example.

Referring to FIG. 2, the collected data regarding usage can shed light on the precise usage levels of toilet paper in a certain environment, and this information can be so detailed that it may have other downstream positive impacts (beyond convenience and automation) that may not be readily apparent.

For example, consider such a system 2 installed in a facility like a nursing home. After a week or more of normal use, the system 2 may recognise a certain equilibrium regarding overall toilet paper use in the facility, as well as toilet paper use on an individual level based on monitoring the usage rates of toilet paper in personal and public toilets throughout the facility. Once these equilibrium states are known, variations from the equilibrium, detected by the system 2, could indicate and be relied upon to identify possible health issues which may correlate with the frequency of bathroom activity, such as bowel movements. One could even isolate the issue down to a specific optical sensor 8 in the system 2 and thus identify specific individuals who may be having digestive or health issues based on the frequency of their bathroom activities.

The above is just one illustrative example of how comprehensive and detailed the data gathered by the present system 2 can be, and how it can be used beyond simply ensuring a facility is stocked with toilet paper 10. Of course, other benefits of having such a smart and automated monitoring system 2 may also be achieved. For example, the system 2 may be accompanied by a software application downloadable onto a user's personal electronic device, such as a smartphone. In addition to allowing the user to customise and configure the system 2 and it's monitoring capabilities, the application may also be configured to perform various automated activities which facilitate the replenishment of toilet paper in the environment of interest. For example, the application may be configured to notify the user when toilet paper is running low as detected by any one of the various devices 4. The application may also be configured to, for example, integrate with location-based services and recognise when a user is near a grocery store and thus prompt the user to purchase toilet paper (and perhaps recommend them a certain amount to buy) based on usage levels. In the case where multiple users share a certain environment and bathroom facilities, the application may of course be configured to enable multiple such users to share data and information with one another such that toilet paper purchasing efforts are not duplicated.

In the case of environments such as a large international hotel, the system 2 can not only help automate and manage the hotel's toilet paper supply chain, analysis of the toilet paper usage data can also reveal information to hotel management about business considerations such as which months or seasons of the year see the highest number of travellers and whether certain toilets throughout the hotel receive more usage than others (which can inform decisions on toilet maintenance, and even the construction of new toilets in more convenient locations so that toilet usage can be more evenly distributed).

As such, embodiments of the present invention relate to a system 2 which provides a smart, power-efficient and distributed IoT solution for monitoring the usage of toilet paper in a designated environment or location. The system 2 can be as simple (e.g. a single optical sensor 8 with a single receiver 12 to monitor a single toilet in a house) or as sophisticated (e.g. hundreds of optical sensors 8 and receivers 12 to monitor an entire hotel or organisation's toilet paper supply chain) as the environment demands.

Before the present system 2, such detailed, rigorous, and accurate data collection and analysis relating to toilet paper usage has never been conducted. The data may thus shed light on and inform numerous areas of concern and decision-making, including financial, health and environmental. Embodiments of devices 4 which may be used in the system 2 will henceforth be described with reference to the Figures.

FIG. 3 shows an embodiment of an optical sensor 8 configured to monitor the usage level of a roll of toilet paper 10. Essentially, the usage level is measured by taking periodic measurements of the diameter of the roll 10 across time. In embodiments of the invention, the optical sensor is short range laser-based optical time-of-flight sensor 8, and thus the diameter of the measured roll 10 can be monitored based on the measured distance between the sensor 8 and an outer diameter of the roll 10.

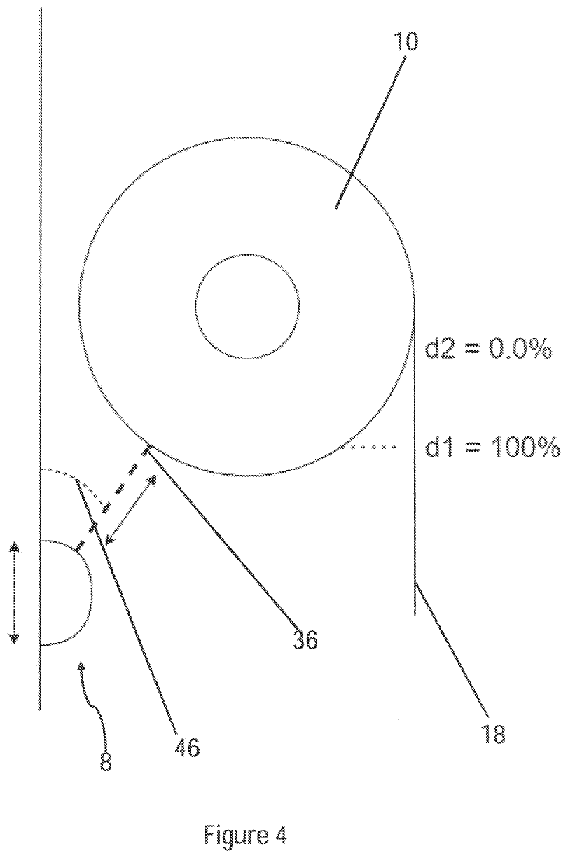

FIG. 4 shows a side view of the sensor 8 releasably mounted to a wall at a height below the toilet roll 10 being monitored. The sensor 8 is preferably mounted and oriented such that a light or laser 36 emitted thereby is pointed in a direction that is substantially perpendicular to the cylindrical exterior wall of the roll 10 being monitored. The sensor 8 is configured to periodically (e.g. every three hours), measure the distance between itself and the exterior wall of the roll 10 and send this information to one or more receivers 12 via BLE.

Before first use, the optical sensor 8 may be calibrated so that it can recognise when a roll 10 is full, and when a roll is empty. In FIG. 4, after the sensor 8 is first mounted to the wall, the user can install a full roll of toilet paper 10 to be monitored. Via the mobile application or other means (e.g. such as a calibration button provided on the sensor), the sensor can thus detect and recognise the distance between itself 8 and an exterior wall of the roll 10 when the roll 10 is full.

Next, the user may replace the full roll 10 with an empty roll, and the sensor 8 can thus detect the distance between itself 8 and the monitored location when the roll is empty. In other embodiments, the application software may store average diameter information about toilet rolls for various types and brands of toilet paper, and thus the user may simply specify the type and brand of toilet paper being used and the sensor 8 can calibrate itself automatically to recognise when the roll will be empty.

In embodiments of the invention, the sensor 8 is preferably installed within a certain range of the roll 10 to be monitored. With reference to FIG. 4, in certain embodiments, the sensor 8 ought to be oriented relative to the monitored roll 10 such that the laser 36 thereof is both substantially perpendicular to the surface of the roll 10 being monitored. In particular, an angle 46 between the laser 36 and the wall to which the sensor 8 is mounted is preferably in a range of 25 to 35 degrees. Data relating to the orientation and distance of the sensor 8 relative to the roll 10 may be sent via BLE to one or more other devices 14, 16 of the system 2.

In embodiments of the system 2, the optical sensor 8 may be provided with an accelerometer to assist with the installation of the sensor 8 in an appropriate or optimal orientation relative to the roll 10 being monitored. For example, in situations where the sensor 8 is installed below the height of the roll 10, it is preferable to orient the roll 10 such that the free end 18 thereof is not adjacent the wall such that the sensor 8 can monitor the diameter of the roll 10 directly (as illustrated in FIG. 4). If the orientation of the roll 10 in FIG. 4 were reversed, the sensor 8 would measure a distance between itself and the free end 18 of the toilet paper roll 10, which can be used to measure a usage level of the roll 10 but may require further calibration. As such, if the accelerometer detects that the sensor 8 is mounted below a height level of the roll 10, the user may be notified, via the application, to ensure that the free end 18 of the roll 10 is not obstructing a direct path between the sensor 8 and an external cylindrical wall of the toilet roll 10 being monitored. Alternatively, the software application may provide a calibration option for the user to select if he or she wishes to monitor the toilet paper roll 10 usage via the distance between the free end 18 thereof and the sensor 8.

By reading accelerometer reported orientation data and varying calibration to correct for alternative orientations of the wall mounted roll holder, the sensor 8 is compatible with a wide range of wall-mounted roll holder solutions available on the market as the sensor 8 is not optically obstructed by the holder's wall mounting.

By mounting the sensor 8 relative to a paper roll 10 held by a conventional wall-mounted roll holder either in the upward or downward facing orientation relative to gravity, the sensor 8 provides a method of detecting the capacity of a single toilet roll 10 via optical methods. This optical detection of individual roll 10 capacity may be facilitated by the angle of optical detection, orientation of the sensor 8, and distance between the sensor 8 and the surface of the roll 10 being monitored.

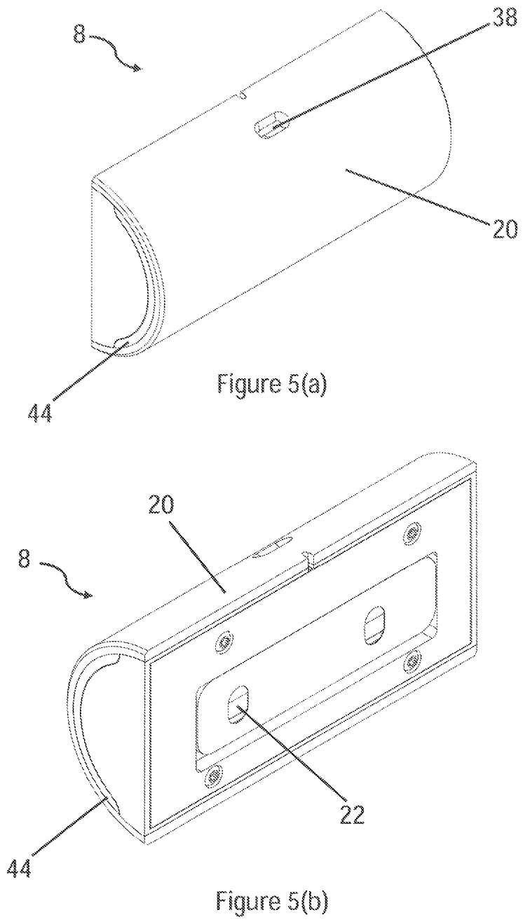

FIGS. 5(a) and 5(b) show front and rear perspective views of embodiments of the sensor 8. The sensor 8 has a main body casing 20 in which is housed light emitting and detecting means 38 and power supply, among other known components for enabling the transmission of measured data from the sensor 8 to one or more receivers 12. It is envisaged that if BLE is used to transmit data periodically, the sensor 8 could be operational for one or more years using a single AA battery.

A rear of the sensor comprises means 22 for releasably mounting it to a wall. Of course, other means, such as adhesives, can also be used. The sensor may also comprise lights 44 in opposed lateral sides there of, which are not only aesthetically pleasing and power efficient, but also provide illumination which can be particularly user friendly if one wishes to visit the toilet in the middle of the night without wanting to turn on other and brighter lights (which can disturb or disrupt sleep). It is envisaged that the colour of the lights 44, and blinking patterns thereof can be configured to indicate various toilet paper statuses to the user, and even if the optical sensor's 8 battery is low and needs replacement.

The sensor 8 may comprise means via which one or more users can be notified. For example, the sensor 8 may comprise a panic button such that if a user in a toilet stall needs assistance, they can easily press the panic button and one or more other users connected to the system 2 would be notified that the person in the stall needed assistance. For example, the main body casing 20 itself of the optical sensor 8 could function as a pressable button.

In the Figures, examples of a receiver 12 of the system 2 are configured as storage means 14. FIGS. 6 to 10 show a first storage means configured in the form of a smart toilet roll holder 14. A base 40 of the holder 14 houses its power supply and various other known components required for wireless interconnectivity. FIGS. 6 to 8 show a first embodiment of the holder 14, having an external cylindrical casing 24 within which several rolls of toilet paper 10 may be stacked vertically on top of one another.

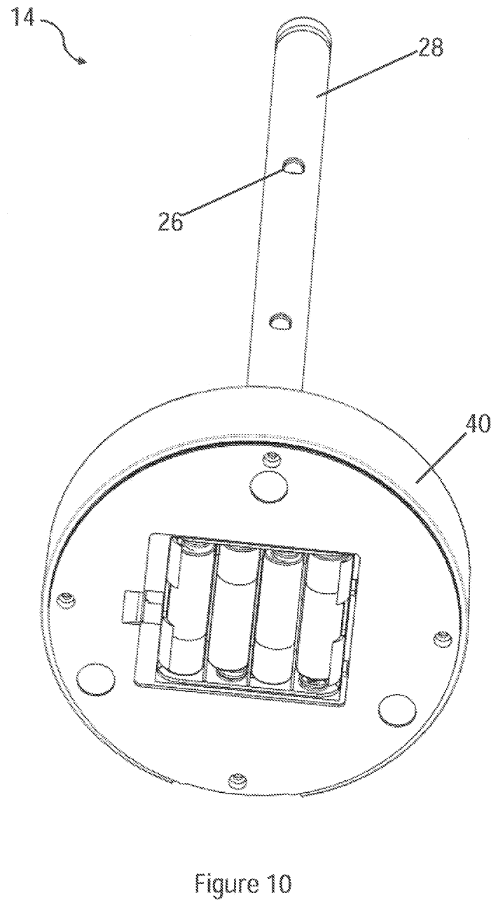

With reference to FIGS. 6 to 9, a maximum of three standard toilet paper rolls 10 may be stored within this example storage means 14, and the casing 24 is correspondingly provided with three vertically spaced apart proximity sensors 26, each configured to detect a presence (or lack thereof) of a corresponding toilet paper roll 10. FIG. 10 shows an alternate embodiment of a smart toilet roll holder 14, wherein proximity sensors 26 provided along a vertical roll-holding rod 28 thereof. Of course, the shape and size of the holder 14 can vary to hold more or less rolls of toilet paper. In another embodiment which is not shown, the storage means can resemble that of FIGS. 6 to 8, though the outer casing 24 is not provided with the sensors 26. Instead, in this embodiment, the storage means would also comprise a central shaft or rod having the sensors 26, not unlike the central rod 28 of the embodiment of FIG. 10.

To conserve power, the proximity sensors 26 may be configured to take a reading only periodically, for example, once every two days. In other embodiments, the proximity sensors 26 may only be configured to take a reading a set time after the smart holder device 14 receives information (e.g. from the optical sensor) that the wall-mounted toilet paper roll 10 is low or empty, since this is when a new roll of paper is most likely to be withdrawn from the smart toilet roll holder 14.

In certain embodiments, the roll storage means 14 may also comprise means for detecting certain events. For example, the storage means 14 may comprise additional sensors (e.g. motion or proximity sensors) for detecting when a person has entered a toilet stall, or when a user has flushed the toilet. Upon detecting such events, the storage means may trigger the corresponding optical sensor 8 to measure the monitored toilet paper roll 10. In such embodiments of the system 2, the optical sensor 8 is thus configured to only take measurements of the in-use toilet roll 10 when it is likely to have been used.

FIGS. 11 to 14 show embodiments of a receiver 12 configured in the form of another type of storage means. This storage means (hereinafter referred to as a storage unit) comprises another smart toilet roll holder 16 capable of storing numerous stacked rolls of toilet paper 10. The storage unit 16 may be wall-mounted or be free-standing and can come in various shapes and sizes to suit the facility being served.

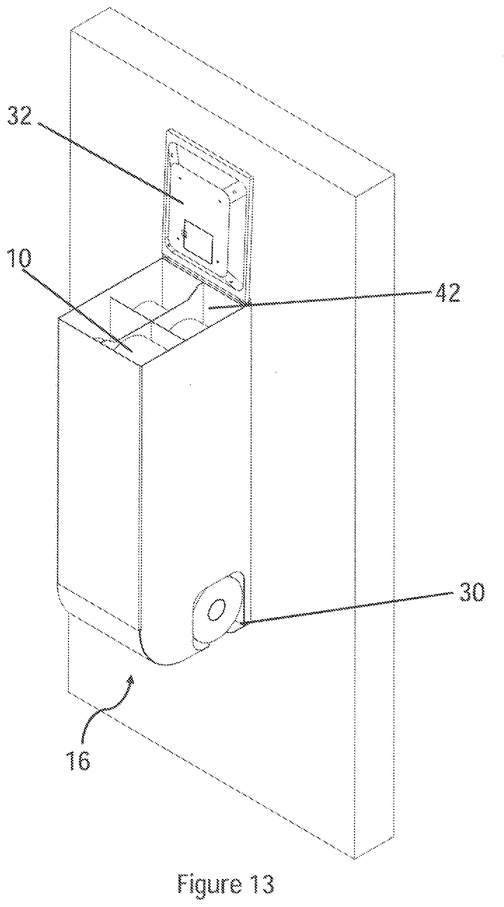

FIG. 13 shows a wall-mounted storage unit 16 with four columns 42 of stacked toilet paper 10 which may be dispensed via a lower opening 30. The unit 16 has an openable lid 32 at its upper end via which rolls 10 can be deposited into the storage unit 16.

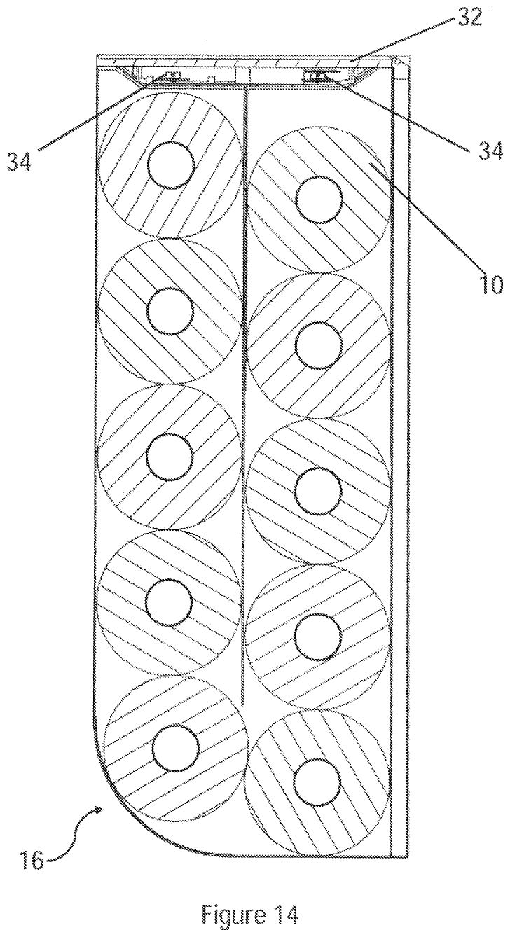

With reference to FIG. 14, the lid 32 comprises sensors 34 configured to monitor the number of rolls 10 within a respective column. The sensors may be optical sensors, such as time-of-flight sensors 34, which periodically emit a light signal downwardly into the storage unit and at the uppermost toilet roll 10. This distance measurement can thus be used to deduce precisely how many rolls 10 are present in the measured column, and this information can be transmitted via Wi-Fi to one or more databases directly, or via one or more other receivers.

Of course, the storage unit 14 may also be configured as previously described with reference to the optical sensors 8 and the smart holder 14, in that it can also comprise features such as a panic button, sensors to detect certain events and triggers, and may be configured to only periodically check for the presence of toilet rolls 10 based on those events.

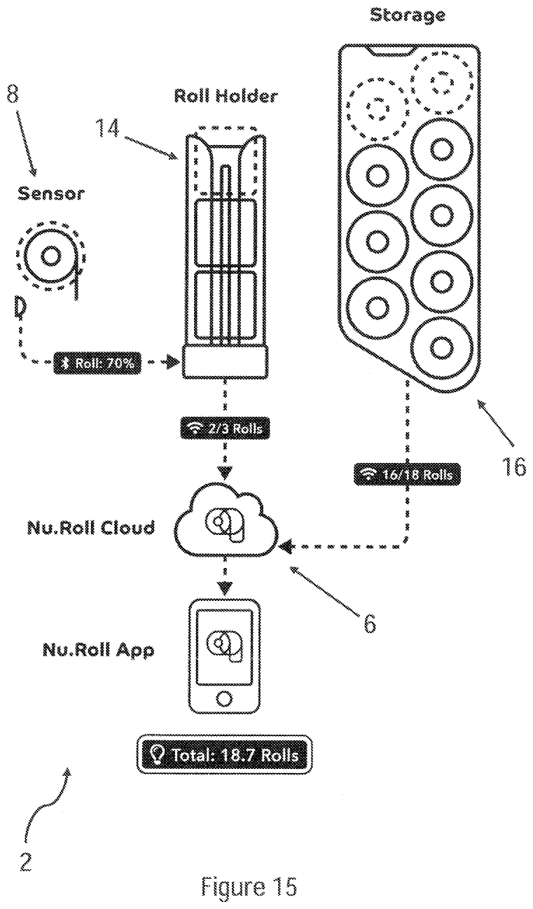

When toilet rolls of a facility or location are exclusively stored and monitored via a system 2 embodying the present invention, the system 2 can accurately quantify the amount of rolls remaining at the facility or location. With reference to FIG. 15, the data collected from the sensor(s) 8, roller holder(s) 14 and storage unit(s) 16 can be aggregated to determine the amount of toilet paper remaining in a certain facility or location, which data may be stored in a database located either in a mobile device and/or remote server.

With embodiments of the present system 2, every location where toilet paper is stored at a location or facility can be accurately monitored and/or automatically replenished as necessary. This automated, monitored and structured storage of toilet paper virtually allow for a hands-off approach to managing and replenishing the toilet paper needs of a predetermined location or facility.

It is envisaged that data associated with metrics such as the amount of toilet paper remaining at a certain location or facility may be dated and recorded (e.g. via mobile device or web application, from a remote or local database) for future recall by the system owners and authorised system data view users.

Many modifications of the above embodiments will be apparent to those skilled in the art without departing from the scope of the present invention. For example, rather than being a standalone wall-mountable device, the optical sensor 8 could be built directly into the holder which holds the in-use toilet roll 10.

While the receivers 12 disclosed herein are embodied within or as part of two types of storage means 14, 16, the receiver can of course be embodied as part of other types of devices, such as hand dryers, soap dispensers, sinks and the like.

It is also envisaged that in efforts to further conserve power, once the system 2 recognises an equilibrium state of usage of the environment being monitored, it could start predicting depletion levels of toilet rolls, and only perform measurements and data transmissions at certain predefined critical events, such as when the holder 14 only contains one roll 10, or when the storage unit 16 only contains 6 rolls. The storage means 14, 16 may also be configured with indicators, such as lights, which turn on to indicate to users when more toilet paper is needed.

In combination with a user's electronic device, such as a smartphone, the system 2 can also provide a range of automated and configurable notifications or actions to facilitate the replenishment and management of the monitored disposable sanitary product. For example, one or more of the devices 4 may be configured to detect the presence of a user, e.g. based on the location of their smartphone, and thus provide relevant alerts or notifications as necessary. For example, if an optical sensor 8 detects that a user is about to enter a stall that is low on toilet paper (or has none), the system 2 could be configured to trigger a smartphone notification which alerts the user to the low toilet paper situation.

Those responsible for the general upkeep and maintenance of a toilet facility, may have differently configured user profiles on the software application so they are notified of various other events. For example, the cleaning staff of an office building may have user profiles set up within the software application such that they are notified if and when certain actions need to be taken in relation to toilet paper management and restocking. For example, the system 2 may detect when a cleaner has entered, or is proximate a toilet which requires maintenance, and thus alert he cleaner of precisely what needs to be done; e.g. it may notify the cleaner that stall numbers three and six on floor five are low on toilet paper, storage unit 16 on floor seven only has five rolls remaining, and even provide information to management regarding toilet paper sales or offers online or nearby.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A system for monitoring toilet paper usage of a location or facility at which the system is installed and providing information associated with said usage, comprising:
(a) a first sensor configured for mounting proximate a toilet paper roll that is to be unspooled for usage, the first sensor being configured to monitor a diameter of the roll and transmit first sensor data associated therewith; and
(b) a storage means configured for placement proximate the first sensor and comprising one or both of:
(i) a toilet roll holder for holding a column of two or more replacement rolls for replacing the monitored roll when it is depleted; and
(ii) a storage unit for storing two or more stacks of replacement rolls for refilling the holder and/or replacing the monitored roll when it is depleted,
the storage means comprising a second sensor for detecting a presence of the held and/or stacked rolls and wirelessly transmitting second sensor data associated therewith,
wherein:
the first sensor is configured to wirelessly transmit the first sensor data to the storage means;
the storage means is configured as a receiver for wirelessly receiving the first sensor data; and
the storage means is configured to wirelessly transmit said first sensor data received from the first sensor and said second sensor data to a database for storage, processing, analysis and/or user notification regarding toilet paper usage.

2. The system of claim 1, wherein either or each of the holder and the storage unit is configured to receive the second sensor data from the other and transmit said second sensor data to the database.

3. The system of claim 1, wherein either or each of the holder and the storage unit is configured to communicate with the first sensor via Bluetooth.

4. The system of claim 1, wherein the holder and the storage unit are configured to communicate with one another via Bluetooth.

5. The system of claim 1, wherein either or each of the holder and the storage unit is configured to transmit the first sensor data and the second sensor data to the database via Wi-Fi.

6. The system of claim 1, wherein toilet paper usage of the location or facility is determined via:
(a) the first sensor data associated with depletion of the monitored roll; and
(b) the second sensor data associated with:
(i) the number of rolls held by the holder; and/or
(ii) the number of rolls stored in the storage unit.

7. The system of claim 1, wherein the first sensor comprises an optical sensor configured to periodically monitor roll diameter and transmit data associated therewith.

8. The system of claim 7, wherein the optical sensor comprises a time-of-flight sensor.

9. The system of claim 1, wherein the first sensor comprises an accelerometer for determining a position of the first sensor relative to monitored roll.

10. The system of claim 1, wherein the first sensor and/or the storage means is configured to detect a presence of a user proximate thereto.

11. The system of claim 1, wherein the second sensor comprises one or both of:
(a) a proximity sensor; and
(b) an optical sensor.

12. The system of claim 1, wherein the second sensor comprises a time-of-flight sensor.

13. The system of claim 1, being configured to take one or more automated actions to facilitate the replenishing of toilet paper rolls based on the toilet paper usage of the location or facility.
